(19) United States
(12) Patent Application Publication
(10) Pub. No.: US 2026/0008240 A1
(43) Pub. Date: Jan. 8, 2026

(54) PP-FRP MEMBER AND METHOD FOR MANUFACTURING THE SAME

(71) Applicant: ART&TECH CO., LTD., Tokyo (JP)

(72) Inventors: Yasushi WATANABE, Tokyo (JP); Hideharu JOHNO, Tokyo (JP)

(73) Assignee: ART&TECH CO., LTD., Tokyo (JP)

(21) Appl. No.: 19/129,637

(22) PCT Filed: Oct. 13, 2023
(86) PCT No.: PCT/JP2023/037167

§ 371 Date: May 13, 2025

(30) Foreign Application Priority Data
Oct. 14, 2022 (JP) 2022-165725

(51) Int. Cl. B29C 70/18; B29C 70/22; B29C 70/46; B29K 23/00; B29K 105/08; B32B 5/02; B32B 5/26

(52) U.S. Cl. CPC B29C 70/18; B29C 70/22; B29C 70/46; B32B 5/022; B32B 5/024; B32B 5/262; B32B 5/266; B29K 2023/10; B29K 2105/0845; B29K 2105/0854; B32B 2260/023; B32B 2260/046

(57) ABSTRACT

By integration of the laminated composite layers to each other, a PP-FRP member having excellent high strength shape-stability and a manufacturing method thereof are provided. A PP-FRP member 100 comprises a plurality of composite layers 111-114 having sheet-like textiles and polypropylene infiltrated and anchored within mesh of the textiles, wherein the plurality of composite layers 111-114 are laminated, the adjacent textiles are in contact with each other, and the polypropylene is filled and integrated within the mesh of the textiles. Thus, the laminated composite layers 111 to 114 are integrated with each other, whereby a high-strength PP-FRP member having excellent shape-stability can be obtained.

### CROSS-REFERENCE TO RELATED APPLICATIONS

This application claims priority to JP Patent Application No. 2022-165725 filed on Oct. 14, 2022, and this application claims priority to and is a 371 of international PCT Application No. PCT/JP2023/037167 filed on Oct. 12, 2023, the entire contents of which are hereby incorporated by reference.

### RELATED ART

### Field of the Invention

The present invention relates to a PP-FRP (Fiber Reinforced Plastics) member and a method for manufacturing the same.

### Description of the Related Art

Conventionally, as a resin decorative molding technique, a method of manufacturing a member by infiltrating a resin into a fiber is known (for example, Patent Documents 1 and 2). In the cases, for example, PVB (polyvinyl butyral) or the like is used. The member in which the resin and the fiber layer are integrated has sufficient strength. In such a member, the base resin layer to be injection molded also infiltrates the gaps between the fibers in the nonwoven fabric layer and is solidified.

In the housing described in Patent Document 1, the nonwoven fabric layer is bonded to the decorative layer via an adhesive resin layer. The adhesive resin layer is made of, for example, PVB (polyvinyl butyral) having sufficient viscosity to allow air bubbles in the adhesive resin layer to escape due to softening. Patent Document 1 also discloses that polypropylene is used as an example of the material of the base resin layer constituting the housing, and that the adhesive resin layer incorporates a conductive wire.

Patent Document 2 discloses a veneer sheet, in which a non-woven fabric mainly containing fibers capable of maintaining a shape at a temperature higher than the melting point of the resin film is interposed between the back surface of the veneer and the resin film and the resin film is configured as if it were a FRP and applied products thereof. For an example of the nonwoven fabric, PET fiber is cited, and for an example of the resin film, a propylene-based film is cited. In the veneer sheet described in Patent Document 2, an anchor effect is generated between the nonwoven fabric and the base resin, thus both of them are firmly bonded.

### PATENT DOCUMENT

Patent Document 1: JP2020-175641 A1

Patent Document 2: JP2013-190839 A2

### SUMMARY OF THE INVENTION

Polypropylene not only can be procured at low cost, but also has excellent chemical resistance, and has potential application in various applications. The inventors of the present invention have worked to make an integrated laminated body using only polypropylene as the resin to be infiltrated into the fibers of the nonwoven fabric. However, even when a plurality of sheets formed of polypropylene are stacked and performed thermocompression bonding, the layer derived from the sheet is peeled off from the product, and it is common knowledge in the molding field that the entire member made of only polypropylene cannot be firmly integrated.

Patent Document 2 discloses a film of propylene as an example of a resin film. However, impregnating the nonwoven fabric with the resin is for fixing the veneer sheet to the veneer, and only a single layer for fixing is formed. Therefore, it is difficult to use the above-described veneer seat as a FRP member which is required to have a shape-stability and strength for designing as in the case of a body of an automotive vehicle.

The present invention has been made in view of such circumstances, and an object of the present invention is to provide a high-strength PP-FRP member having excellent shape-stability by integrating laminated composite layers, and a method for manufacturing the same.

### Means for Solving the Problems

(1) In order to achieve the above object, the present invention provides the following means. That is, the PP-FRP member of the present invention comprises a plurality of composite layers having sheet-like textiles and polypropylene infiltrated and anchored within mesh of the textiles, wherein the plurality of composite layers are laminated, the adjacent textiles are in contact with each other, and the polypropylene is filled and integrated within the mesh of the textiles. Thus, a high-strength PP-FRP member having excellent shape-stability can be obtained by integrating the laminated composite layers.

(2) Further, in the PP-FRP member according to the above (1), the textile constituting any of the plurality of composite layers is a nonwoven fabric. Thus, it can be easily formed by stacking and pressing the prepreg obtained by infiltrating polypropylene into the nonwoven fabric.

(3) Further, in the PP-FRP member according to the above (1), one of the textiles constituting adjacent composite layers among the plurality of composite layers is a nonwoven fabric, and the other is a woven fabric. Such a structure is formed by sandwiching a woven fabric between prepregs, and thus the shape stability is improved.

(4) Further, the PP-FRP member according to any one of the above (1) to (3), further comprises a conductive material provided between the textiles of the plurality of adjacent composite layers. Thus, various functions can be obtained by the conductive material.

(5) Further, in the PP-FRP member according to any one of the above (1) to (4), the polypropylene has a melting point of 160° C. or lower. This allows for lower-temperature processing and allows the PP-FRP member to be used, for example, for surface decoration.

(6) Further, in the PP-FRP member according to any one of the above (1) to (5), the polypropylene comprises a tackifier of 5 wt % or more and 30 wt % or less. Thus, the prepreg can be easily prepared by the hot melt.

(7) Further, in the PP-FRP member according to any one of the above (1) to (6), when hot pressing is performed at a temperature of 100° C. or higher and 150° C. or lower and a pressure of 2.5 MPa or lower, a change rate of length before and after the hot pressing is 18 or less. In this way, the excellent shape-stability of PP-FRP member facilitates its application.

(8) Further, a manufacturing method of PP-FRP member of the present invention comprises the steps of superposing a plurality of prepreg sheets having a nonwoven fabric and polypropylene impregnated in the nonwoven fabric to form a first superposed body, and hot pressing the first superposed body at a predetermined temperature or higher and at a predetermined pressure or higher. Thus, a plastic member having excellent chemical resistance at a low cost and having a dense and high strength can be manufactured.

(9) Further, the manufacturing method of PP-FRP member according to the present invention comprises the steps of alternately superposing a plurality of prepreg sheets having a woven fabric and polypropylene impregnated in the woven fabric and sheet-like textiles to form a second superposed body, and hot pressing the second superposed body at a predetermined temperature or higher and at a predetermined pressure or higher. Thus, a plastic member having excellent chemical resistance at a low cost and having a dense and high strength can be manufactured. Further, the shape stability can be improved.

(10) Further, in the PP-FRP member according to the above (8) or (9), the predetermined temperature is 100° C. or higher and 150° C. or lower, and the predetermined pressure is 1.5 MPa or higher and 2.5 MPa or lower. Thus, the laminated composite layers are integrated to obtain a high-strength PP-FRP member having excellent shape-stability.

### BRIEF DESCRIPTION OF THE DRAWINGS

FIG. 1 is a cross-sectional view showing a PP-FRP member.

FIGS. 2A to 2C are cross-sectional views showing the respective steps of the prepreg production.

FIG. 3 is a perspective view showing a step of thermocompression bonding the prepregs in a stacked manner.

FIGS. 4A to 4D are cross-sectional views showing the steps of forming and trimming, respectively.

FIG. 5 is a perspective view showing a step of thermocompression bonding a prepreg and a textile.

FIGS. 6A and 6B are cross-sectional views showing PP-FRP members with an embedded conductive wire and element, respectively.

FIG. 7 is a photomicrograph of a section.

### DETAILED DESCRIPTION OF THE INVENTION

The inventors of the present invention have made a PP-FRP member by repeating trial and error and superposing a prepreg in which polypropylene is infiltrated and fixed to a sheet-like nonwoven fabric, and bonding the prepregs by thermocompression bonding, thereby achieving the present invention. By making the polypropylene which infiltrates into the mesh of the nonwoven fabric and is fixed by a plurality of layers, the laminated body can be firmly integrated while maintaining the shape stability. Hereinafter, embodiments of the present invention are described in detail with reference to the drawings.

### First Embodiment

### Configuration of PP-FRP Member

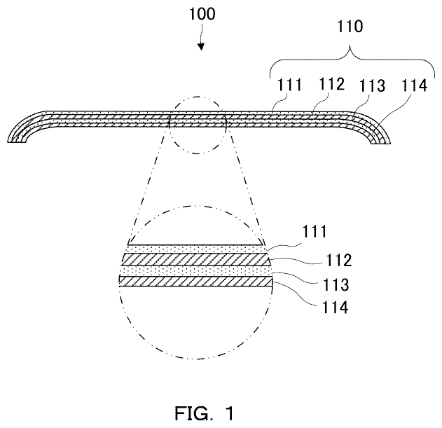

FIG. 1 is a cross-sectional view showing a PP-FRP member 100. The configuration shown in FIG. 1 is exemplary, and a PP-FRP member 100 is composed of the combined layers 111 to 114. The composite layers 111 to 114 are laminated and each of the composite layers 111 to 114 is formed of the textile and the polypropylene that is infiltrated and anchored within the mesh of textile.

In composite layers 111 to 114, polypropylene is continuously present beyond the layers and infiltrates into the mesh of the textiles. Due to the anchoring effect of the infiltrated polypropylene, each of the composite layers 111 to 114 is firmly bonded to an adjacent layer. In this way, a firmly integrated plate-like member is formed.

It is preferable that the polypropylene contains tackifier of 5 wt % or more and 30 wt % or less. Tackifier is tackifying resin, for example petroleum-based one. This facilitates preparation of the prepreg by hot melt.

As the polypropylene, one having a high melting point can be used. Such a high melting point polypropylene is a material of a high shrinkage type and can be used as a member for a product requiring a high elastic modulus. The high melting point polypropylene is preferably, for example, one having a melting point of 150° C. or higher. Such high melting point polypropylene is preferably composed of polypropylene of 85 wt % or more and 9 5wt % or less and tackifier of 5 wt % or more and 15 wt % or less.

Also, polypropylene having a low melting point can be used. Such low melting point polypropylene is of a low shrinkage type and is slightly softer than high melting point polypropylene. It can be used for impregnation into a synthetic fiber fabric having a low heat-resistant temperature such as polyethylene reinforcing fibers. The low melting point polypropylene is preferably, for example, one having a melting point of 100° C. or lower. Such low melting point polypropylene is preferably composed of polypropylene of 70 wt % or more and 85 wt % or less and tackifier of 15 wt % or more and 30 wt % or less.

The polypropylene preferably has a melting point of at least 160° C. or lower. This allows processing at low temperatures and joining with members having different melting points. For example, a surface decorated member made of polypropylene having a higher melting point can be formed, and the member and PP-FRP member can be joined together.

The textiles contained in each of the composite layers 111-114 are preferably all non-woven fabrics or alternately overlapping non-woven fabrics and woven fabrics. The nonwoven fabric is preferably a spunbond nonwoven fabric, and particularly preferably a spunbond nonwoven fabric containing polyester. The nonwoven may be a papermaking-based nonwoven or felt comprising polyester. As the textile, one having a basis weight 20 g/m² or more and 300 g/m² or less can be used.

As the nonwoven fabric, a nonwoven fabric made of polypropylene can also be used. Nonwoven fabrics made of polypropylene have a high bulk. For example, when a nonwoven fabric made of polypropylene having a basis weight 20 g/m² or more and 70 g/m² or less is used, the polypropylene softened in the hot melt process is easily impregnated due to the high porosity. In this case, there is also a cost advantage that a composite layer having the same thickness can be formed with a small number of nonwoven fabrics. Furthermore, a composite layer formed by impregnating polypropylene into a nonwoven fabric made of polypropylene does not require separation from material to material for recycling.

As the woven fabric, a polyethylene-reinforced fiber woven fabric can be used. When a polyester nonwoven fabric is used, the number of basic weight is preferably not less than 30 g/m² and not more than 250 g/m². As a result, the softened polypropylene is easily impregnated.

In PP-FRP member 100, the composite layers 111 to 114 have a four-layer configuration, but may be laminated in other numbers. The four-layer configuration or more improves the strength of PP-FRP member 100 and stabilizes the shape. On the other hand, if the thickness is less than the four-layer configuration, molding is facilitated.

### Method for Manufacturing PP-FRP Member

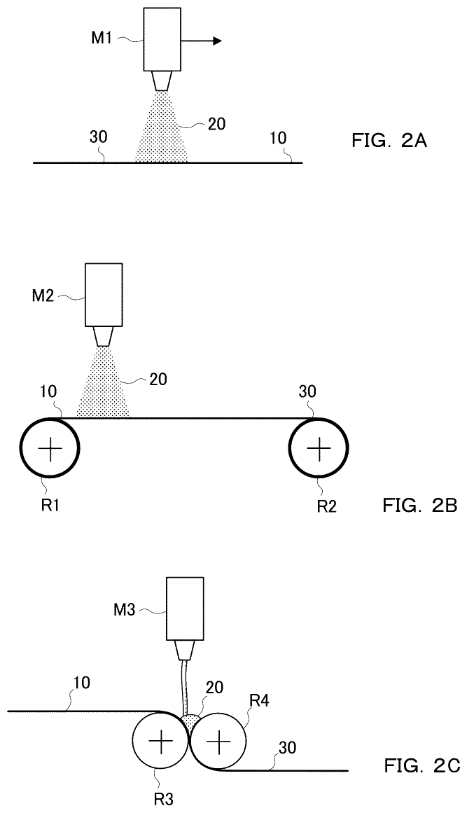

A method for manufacturing PP-FRP member 100 configured as described above is described below. PP-FRP member 100 is manufactured by processes of prepreg manufacturing, a thermocompression bonding, a preform forming and a trimming. FIGS. 2A to 2C are cross-sectional views showing the respective processes of the prepreg production.

First, a prepreg is prepared. For example, as shown in FIG. 2A, the sheet-like nonwoven fabric 10 is placed with the front surface thereof horizontally, the polypropylene 20 softened by being heated to a temperature exceeding the softening point are applied, infiltrated and fixed thereon, and thus the prepreg 30 can be produced. For the nonwoven fabric 10, a nonwoven fabric with a thickness of 50 μm or more and 500 μm or less is preferably used.

For application, a device called a melter can be used as a hot melt coater. An exemplary device shown in FIG. 2A is a sheet-fed coater, in which the nonwoven fabric 10 is fixed, and the spray-type nozzle portion M1 is moved over the entire nonwoven fabric 10, whereby the polypropylene 20 is applied to the nonwoven fabric 10, whereby the prepreg 30 can be produced.

An exemplary device shown in FIG. 2B is a roll-to-roll continuously impregnating device. By fixing the spray-type nozzle portion M2 and moving the nonwoven fabric 10 from the roll R1 to the roll R2, the polypropylene 20 can be applied to the entire nonwoven fabric 10 to produce the prepreg 30. In the coating machine as described above, at the time of coating, it is preferable that one of the coating machine and the nonwoven fabric is moved at a constant speed with respect to the other.

The device shown in FIG. 2C is also a continuously impregnating device using rolls. The discharge-type nozzle M3 is fixed and the polypropylene 20 is fed to a position between the roll R3 and R4. The nonwoven fabric 10, which is sandwiched between the roll R3 and R4 and fed out, is infiltrated with polypropylene 20. The production efficiency of the prepreg 30 can be improved by using such a continuously impregnating device.

The heated and softened polypropylene may be stored in a container, and a sheet-like textile may be immersed in the container (so-called “hot-dipping”). The polypropylene thus infiltrated into the textile is cooled and hardened to form a prepreg. In this case, it is preferable that the textile is continuously moved at a constant speed by rotation of a roller or the like and passed through the inside of the polypropylene.

The sheet-like prepreg thus obtained preferably has a thickness of 100 μm or more and 1500 μm or less, and more preferably has a thickness of 100 μm or more and 500 μm or less.

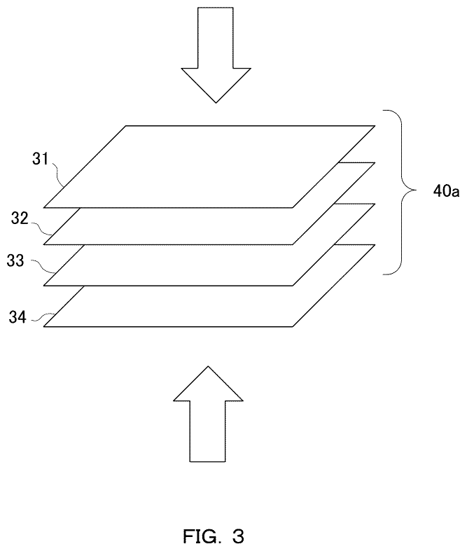

The obtained plurality of sheet-like prepregs 30 are arranged so as to be stacked each other according to a predetermined design and form a superposed body (first superposed body). Then, the placed superposed body is heated, pressed, and thermocompression bonded. FIG. 3 is a perspective view showing a step of thermocompression bonding the prepregs in a stacked manner. In an example shown in FIG. 3, the superposed body 40a formed by being superposed four prepregs 31 to 34 is pressed from above and below while being heated. As a result, a sheet-like laminated body is formed.

Thermocompression bonding is preferably performed by hot press at a predetermined temperature or higher and a predetermined pressure or higher using a hydraulic hot press machine or a multi-stage press machine. The predetermined temperature is the softening point of the polypropylene or higher and the melting point of the polypropylene or lower. For example, it is preferable to heat to 140° C. or higher and 160° C. or lower. The predetermined pressure is preferably 1.5 MPa or higher and 2.5 MPa or lower. This allows the polypropylene to infiltrate and fix to the mesh in the textile, thereby generating an anchoring effect and allowing the members to be firmly integrated.

As described above, the prepreg is

thermocompression bonded at a temperature higher than the softening point of the polypropylene and lower than the melting point, so that the polypropylene infiltrated into the mesh is continuously integrated and firmly adhered to the mesh by the anchor effect. As a consequence, a sheet of PP-FRP member 100 is formed as a laminated sheet in which a plurality of nonwoven fabrics are firmly bonded to each other by the polypropylene spread by the infiltration.

The PP-FRP member 100 is excellent in shape-stability, and when hot-pressed at a temperature of 100° C. or higher and 150° C. or lower and a pressure of 2.5 MPa or lower, the absolute value of the change rate of the length before and after the pressing is 18 or less. As described above, the PP-FRP member is less likely to change in size before and after the pressing. Therefore, it is possible to form PP-FRP member as designed, which facilitates its application.

The PP-FRP member 100 can achieve shape-stability by being naturally cooled after being laminated by thermocompression bonding. Therefore, mass production can also be performed at the same time using a multi-stage press machine. The multistage press machine is a hot press machine in which a hot plate is arranged in the middle in addition to the upper and lower hot plates, and a plurality of openings are provided as stages sandwiching the material. A plurality of PP-FRP members can be formed at the same time by sandwiching the materials between a plurality of stages and pressing them by a press while being heated.

The PP-FRP member has a high strength because it has a composite-layer configuration in which polypropylene is infiltrated and fixed in textiles. Accordingly, the present invention can be used for a member that requires lightweight and strength, such as a body part of an automobile.

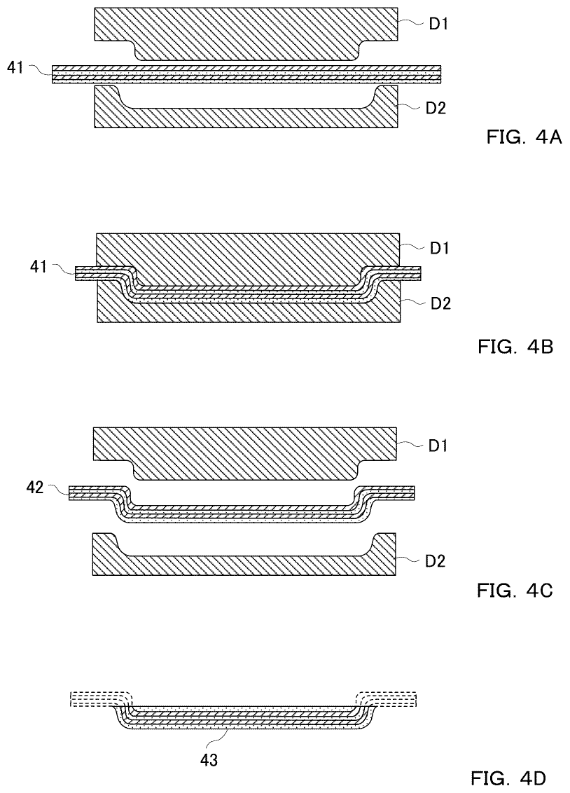

The sheet of PP-FRP member 100 obtained in the above-described process is formed and trimmed. FIGS. 4A to 4D are cross-sectional views showing the steps of forming and trimming, respectively. First, the laminated body 41 is softened by heating. Then, as shown in FIG. 4A, the laminated body 41 is disposed between the core mold D1 and the cavity mold D2.

Next, as shown in FIG. 4B, the core mold D1 and the cavity mold D2 are clamped together. As a result, the laminated body 41 is shaped. After clamping, as shown in FIG. 4C, the core mold D1 and the cavity mold D2 are opened, and the obtained formed body 42 is released. Then, as shown in FIG. 4D, unwanted parts are removed by trimming to obtain a formed body 43. Even after such a forming process, the change rate in length from the laminated body 41 to the formed body 43 is 1% or less, and the PP-FRP member 100 is excellent in shape-stability. The obtained PP-FRP member 100 is further cut according to the application as appropriate. The PP-FRP member 100 can be applied to various articles made of polypropylene as a surface material.

### Second Embodiment

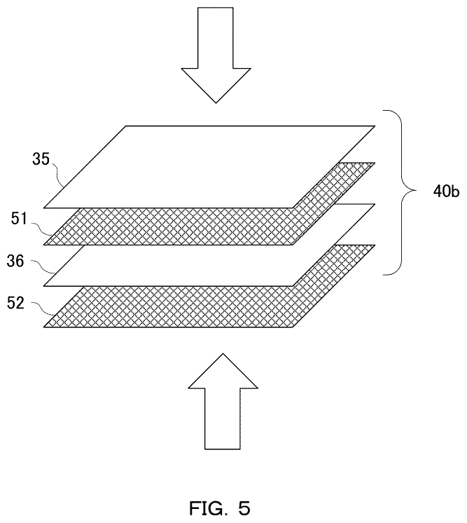

In the above-described embodiment, only the prepreg is stacked and thermocompression bonded, but the prepreg and the textile may be alternately stacked and thermocompression bonded. FIG. 5 is a perspective view showing a step of thermocompression bonding a prepreg and a textile. Textiles that alternate with the prepreg are woven or non-woven. In the embodiment shown in FIG. 5, a superposed body 40b (second superposed body) in which two prepregs 35 to 36 and two textiles 51 to 52 are alternately superposed is formed, and the superposed body 40b is thermocompression bonded. As a result, a sheet-like laminated body is formed. Thermocompression bonding in this case can also be performed under the same temperature conditions using the same equipment as in the first embodiment.

In this case as well, the prepreg and the textile are thermocompression bonded at a temperature higher than the softening point and lower than the melting point of the polypropylene, whereby the polypropylene in the prepreg also infiltrates into the mesh of the textile and is firmly adhered to the mesh by the anchor effect. Consequently, the sheet of PP-FRP member 100 is formed as a laminated sheet in which the prepreg and the textile are bonded to each other by the polypropylene continuously spread by the infiltration.

### Third Embodiment

### Configuration of Circuit-Member-Embedded PP-FRP Member

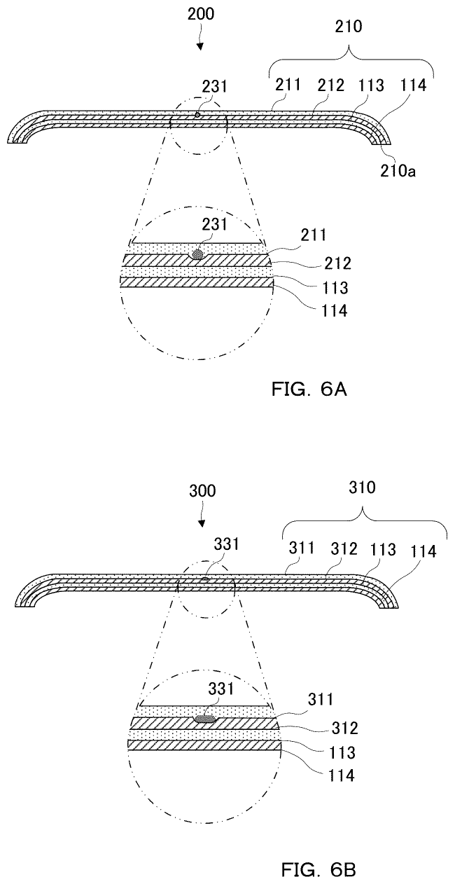

Conductors may be embedded in the main body layer of PP-FRP member 100. FIGS. 6A and 6B are cross-sectional views showing PP-FRP members 200 and 300 with a conductive wire and element embedded in the body layer, respectively. The PP-FRP member 200 is essentially constructed similar to the PP-FRP member 100 but has embedding of the conductor 231 and associated features thereof.

In the PP-FRP member 200, a conductive wire 231 is provided between the composite layer 211 and the composite layer 212. As described above, the PP-FRP member 200 which is firmly integrated with the polypropylene and has a function added by the conductive wire 231 provided therein can be configured.

In the exemplary embodiment shown in FIG. 6A, a conductive wire 231 having a circular cross section is provided between the composite layer 211 and the composite layer 212. The conductor 231 is, for example, a conductive wire for power supply or control of each device. Since PP-FRP member 200 is formed by thermocompression bonding with the conductive wire 231 interposed therebetween, a semicircular depression corresponding to the cross-sectional shape of the conductive wire is formed in the composite-layer 212 pressed against the conductive wire 231. As the composite layers 211 and 212 are flexibly deformed in this manner, the surface on the composite layer 211 can be smoothed. Since the conductive wire 231 is buried between the composite layers, there is no problem even if the conductive material is exposed without an insulating coating.

In the above example, the conductive wires 231 are provided between the nonwoven fabrics in the composite layer but may be provided between the nonwoven fabrics and the woven fabrics when the nonwoven fabrics and the woven fabrics are alternately provided. That is, the conductive wire 231 may be embedded in a plurality of layers constituting the PP-FRP member 200 and may be embedded anywhere between the layers.

On the other hand, the PP-FRP member 300 is basically configured in the same manner as the PP-FRP member 200 but differs in the element 331 embedded in the PP-FRP member 300 and associated features thereof. In the embodiment shown in FIG. 6B, an element having a flat cross section is provided as the element 331 between the composite layer 311 and the composite layer 312. In the composite layer 312 pressed by the element 331 in the manufacturing process, a flat-plate-shaped depression corresponding to the cross-sectional shape of the element is generated.

The manufacturing processes of the PP-FRP members 200 and 300 are the same as those of the PP-FRP member 100. However, the difference is that the conductive wire 231 or the element 331 is arranged between the prepreg and the textile during the arrangement.

### Large Member and Housing

The PP-FRP member can be used as a large-sized member or a housing requiring strength, for example, in an automotive body, a bumper, or a residential facility. Since the PP-FRP member is excellent in shape-stability and does not change in size due to shrinkage after the thermocompression bonding process, a large member can be manufactured as designed as an alternative to steel product. The surface layer of the PP-FRP member can also be coated by decorating a polyester nonwoven or woven fabric as a coated base fabric and formed with PET resin. In this way, the present invention can also be applied to a member which is indispensable to painting such as an automobile exterior. Further, by using a polyester conductive woven fabric for the surface layer decoration, it is also possible to make the entire member uncharged.

### Wire Harness

A PP-FRP member, which is embedded with a conductive wire for supplying power to the device and a conductive wire for transmitting an electric signal for controlling the device, may be used for a wire harness. Since the conductive wire is embedded between the composite layers, it is possible to realize a wire harness that is less likely to cause a defect such as a short circuit of the circuit. A touch panel or an antenna may be incorporated in the PP-FRP member.

### Toilet Seat

A PP-FRP member in which a heater wire is embedded as a conductive body can also be used for a toilet seat. The toilet seat is a so-called warm toilet seat, and the temperature of the surface can be maintained at about 40° C. by applying a current to the heater wire. The material of the heater wire is not particularly limited. It is possible to realize a warm toilet seat having a surface formed of polypropylene excellent in hydrochloric acid resistance. When a heater wire is provided directly below the composite layer of the surface, heat can be easily conducted to the surface, and thermal efficiency can be improved. In addition, the PP-FRP member can be used for the toilet seat without embedding the heater wire. In this case, it is preferable to use a surface layer material that has been subjected to a pleasant-feel-textured process such as raising fabric.

### Backer

The PP-FRP member can be used as a backer of a composite laminated body of PP films and nonwoven fabrics. It can also be used as a backer of a composite laminated body of a resin-film such as PMMA, PET, PC and nonwoven fabric. In this process, PVB resin is used as an adhesive for bonding the resin films to the nonwoven fabric. Further, as the base resin, a resin such as an ABS resin, PP, PC, PMMA and so forth may be injection-molded on the back surface. As described above, the member can be applied to various applications as a low-weight intermediate processing raw material having a processing temperature of, for example, about 120 to 150° C.

### Experiment 1

The hot-melt polypropylene (HMPP) to which the tackifier was added was heated to soften, and the above-described softened polypropylene was applied to a nonwoven fabric formed of a spunbonded polyester to prepare a prepreg. As the nonwoven fabric, a nonwoven fabric N2070-6S manufactured by Toray Industries, Inc. was used. A prepreg using hot-melt polypropylene (PP80 wt %, tackifier 20 wt %) having a low melting point (95° C.) is referred to as “prepreg 2” for convenience. The resulting prepreg was used to superpose the materials in the following combinations.

TABLE 1

| SAMPLE | COMBINATION | PREPREG 2 |
|---|---|---|
| LAMINATED | NONWOVEN FABRIC, PREPREG 2 | USING LOW |
| BODY | (130 g/m²), BLACK NONWOVEN | MELTING |
| SAMPLE 1 | FABRIC, PREPREG 2 (60 | POINT |
| | g/m²), NONWOVEN FABRIC | (95° C.) |
| LAMINATED | NONWOVEN FABRIC, PREPREG 2 | HMPP |
| BODY | (110 g/m²), COARSE WHITE | |
| SAMPLE 2 | NONWOVEN FABRIC, PREPREG 2 | |
| | (60 g/m²), NONWOVEN FABRIC | |
| LAMINATED | NONWOVEN FABRIC, | |
| BODY | LAMINATING EACH LAYER OF 9 | |
| SAMPLE 3 | LAYERS OF PREPREG 2 (110 | |
| | g/m²) AND 8 LAYERS OF | |
| | NONWOVEN FABRIC | |
| | ALTERNATELY, NONWOVEN | |
| | FABRIC | |

Black nonwoven fabrics are denser and harder than conventional nonwoven fabrics. As the black nonwoven fabric, a nonwoven fabric G2200-BKO manufactured by Toray Industries, Inc. was used. Coarse white nonwoven fabrics are less dense than conventional nonwoven fabrics. As the coarse white nonwoven fabric, a nonwoven fabric D5100 manufactured by Toray Industries, Inc. was used.

A square of approximately one side 100 mm was drawn with a sine pen having a pen tip with thickness 0.5 mm on the surface of the sample on which the material was superposed, and the lengths of the respective sides were measured twice and averaged. Lengths were measured using a digital caliper to 0.01 mm units (the same shall apply hereinafter). Thermocompression bonding was performed by pressing each sample for 1 minute using a hydraulic hot press machine. At the time of thermocompression bonding of the laminated body sample 3, the spacer of 15 mm was bitten to prevent the sample from becoming too flat and collapsed with deviating from the target of the compression bonding.

The lengths of the respective sides of the

square were measured twice after thermocompression bonding, and they were averaged. In each of the laminated body samples 1 to 3 obtained as PP-FRP members, the change rate of the length of the square was 1% or less. The measurement results are shown in the following table.

TABLE 2

| | | | | BEFORE | AFTER | |
|---|---|---|---|---|---|---|
| | | | | THERMO- | THERMO- | |
| | TEMPER- | PRES- | | COMPRESSION | COMPRESSION | CHANGE |
| SAMPLE | ATURE(° C.) | SURE(MPa) | SPACER(mm) | BONDING(mm) | BONDING(mm) | RATE(%) |
| LAMINATED | 100 | 1.5 | NONE | 100.70 | 100.29 | −0.41 |
| BODY | | | | | | |
| SAMPLE 1 | | | | | | |
| LAMINATED | | | NONE | 100.81 | 100.52 | −0.29 |
| BODY | | | | | | |
| SAMPLE 2 | | | | | | |
| LAMINATED | | | 15 | 100.49 | 100.48 | −0.0062 |
| BODY | | | | | | |
| SAMPLE 3 | | | | | | |

Next, a prepreg using hot-melt polypropylene (PP90 wt %, tackifier 10 wt %) having a high melting point (155° C.) and a prepreg using hot-melt polypropylene having a low melting point (95° C.) were stacked, and a sample in which both ends were sandwiched by nonwoven fabrics was thermocompression bonded. A prepreg using hot-melt polypropylene having a high melting point (155° C.) is referred to as “prepreg 1” for convenience. Materials were superposed in the following combinations:

TABLE 3

| SAMPLE | COMBINATION | PREPREG 1 | PREPREG 2 |
|---|---|---|---|
| LAMINATED | NONWOVEN FABRIC, | USING | USING |
| BODY | LAMINATING EACH | HIGH | LOW |
| SAMPLE 4 | LAYER OF 5 LAYERS OF | MELTING | MELTING |
| | PREPREG 1 (60 g/m²) | POINT | POINT |
| | AND 4 LAYERS OF | (155° C.) | (95° C.) |
| | PREPREG 2 (60 g/m²) | HMPP | HMPP |
| | ALTERNATELY, | | |
| | NONWOVEN FABRIC | | |
| LAMINATED | NONWOVEN FABRIC, | | |
| BODY | LAMINATING EACH | | |
| SAMPLE 5 | LAYER OF 2 LAYERS OF | | |
| | PREPREG 1 (60 g/m²) | | |
| | AND 3 LAYERS OF | | |
| | PREPREG 2 (40 g/m²) | | |
| | ALTERNATELY, | | |
| | NONWOVEN FABRIC | | |

A square of approximately one-sided 100 mm was drawn with a sine pen on the surface of the sample obtained by superposing materials, and the lengths of the respective sides were measured twice and averaged. Thermocompression bonding was performed by pressing each sample for 1 minute using the hydraulic hot press machine. The lengths of the respective sides of the square were measured twice after thermocompression bonding, and they were averaged. In each of the laminated body samples 4 and 5 obtained as a PP-FRP member, the change rate of the length of the square was 1% or less. The measurement results are shown in the following table.

TABLE 4

| | | | | BEFORE | AFTER | |
|---|---|---|---|---|---|---|
| | | | | THERMO- | THERMO- | |
| | TEMPER- | PRES- | | COMPRESSION | COMPRESSION | CHANGE |
| SAMPLE | ATURE(° C.) | SURE(MPa) | SPACER(mm) | BONDING(mm) | BONDING(mm) | RATE(%) |
| LAMINATED | 120 | 1.5 | NONE | 100.71 | 100.66 | −0.16 |
| BODY | | | | | | |
| SAMPLE 4 | | | | | | |
| LAMINATED | | | | 100.60 | 100.51 | −0.089 |
| BODY | | | | | | |
| SAMPLE 5 | | | | | | |

Next, a sample obtained by stacking a prepreg using hot-melt polypropylene having a high melting point (155° C.) and a nonwoven fabric was thermocompression bonded. Materials were superposed in the following combinations:

TABLE 5

| SAMPLE | COMBINATION | PREPREG 1 |
|---|---|---|
| LAMINATED | NONWOVEN FABRIC, LAMINATING | USING |
| BODY | EACH LAYER OF 3 LAYERS OF | HIGH |
| SAMPLE 6 | PREPREG 1 (60 g/m²) AND 2 | MELTING |
| | LAYERS OF NONWOVEN FABRIC | POINT |
| | ALTERNATELY, NONWOVEN | (155° C.) |
| | FABRIC | HMPP |
| LAMINATED | NONWOVEN FABRIC, LAMINATING | |
| BODY | EACH LAYER OF 9 LAYERS OF | |
| SAMPLE 7 | PREPREG 1 (60 g/m²) AND 8 | |
| | LAYERS OF NONWOVEN FABRIC | |
| | ALTERNATELY, NONWOVEN | |
| | FABRIC | |

A square of approximately one-sided 100 mm was drawn with a sine pen on the surface of the sample obtained by superposing materials, and the lengths of the respective sides were measured twice and averaged. Thermocompression bonding was performed by pressing each sample for 1 minute using the hydraulic hot press machine. The lengths of the respective sides of the square were measured twice after thermocompression bonding, and they were averaged. In each of the laminated body samples 6 and 7 obtained as a PP-FRP member, the change rate of the length of the square was 1% or less. The measurement results are shown in the following table.

TABLE 6

| | | | | BEFORE | AFTER | |
|---|---|---|---|---|---|---|
| | | | | THERMO- | THERMO- | |
| | TEMPER- | PRES- | | COMPRESSION | COMPRESSION | CHANGE |
| SAMPLE | ATURE(° C.) | SURE(MPa) | SPACER(mm) | BONDING(mm) | BONDING(mm) | RATE(%) |
| LAMINATED | 160 | 2.5 | NONE | 100.79 | 100.01 | −0.77 |
| BODY | | | | | | |
| SAMPLE 6 | | | | | | |
| LAMINATED | | | | 100.60 | 99.38 | −1.2 |
| BODY | | | | | | |
| SAMPLE 7 | | | | | | |

As described above, it was shown that the change rate of the length was 1% or less before and after the thermocompression bonding in any of the laminated body samples, and the shape stability was extremely excellent. Especially when laminating the prepreg using the hot melt polypropylene of the low melting point, the thermocompression bonding at a relatively low temperature of 120° C. or lower, the change rate was 0.4% or less. In addition to the shape stability at the result of manufacturing a PP-FRP member, a PP-FRP member after manufacturing has a change rate of 1% or less when hot-pressed at a temperature of 100° C. or higher and 150° C. or lower and a pressure of 2.5 MPa or lower, it can be seen that the shape stability is extremely excellent.

### Experiment 2

For comparative purposes, a 100% polypropylene (PP) film in the thickness 0.5 mm were heat treated for 1 minute. The heat treatment was carried out at the following temperatures, pressures and measurement conditions. Prior to the heat treatment, a square of approximately one-sided 100 mm was drawn with a sine pen on the surface of the sample, and the lengths of the respective sides were measured twice and averaged. In addition, the lengths of the respective sides of the square were measured twice after the heat treatment, and they were averaged to calculate the rate of change.

TABLE 7

| | | | | BEFORE | AFTER | |
|---|---|---|---|---|---|---|
| | | | | THERMO- | THERMO- | |
| | TEMPER- | PRES- | | COMPRESSION | COMPRESSION | CHANGE |
| SAMPLE | ATURE(° C.) | SURE(MPa) | SPACER(mm) | BONDING(mm) | BONDING(mm) | RATE(%) |
| PP FILM | 80 | 2 | 12 HOURS OR | 100.22 | 100.21 | −0.010 |
| SAMPLE 1 | | | MORE AFTER | | | |
| PP FILM | 100 | 2 | HEATING | 100.26 | 99.94 | −0.32 |
| SAMPLE 2 | | | | | | |
| PP FILM | 120 | 2 | | 100.34 | 99.87 | −0.47 |
| SAMPLE 3 | | | | | | |
| PP FILM | 160 | 2 | IMMEDIATELY | 100.31 | 102.95 | 2.6 |
| SAMPLE 4 | | | AFTER | | | |
| PP FILM | 160 | 0 | HEATING | 100.25 | 99.38 | −0.87 |
| SAMPLE 5 | | | | | | |
| PP FILM | 180 | 2 | | 100.28 | 125.65 | 25 |
| SAMPLE 6 | | | | | | |
| PP FILM | 180 | 0 | | 100.20 | 98.98 | −1.2 |
| SAMPLE 7 | | | | | | |

It was found that when 2 MPa was pressurized above the softening point as in polypropylene film samples 4 and 6, the shapes changed. As for these, the rate of change is more than 18, it can be seen that sufficient shape stability cannot be obtained even when a laminated body is produced by pressing a polypropylene film.

### Experiment 3

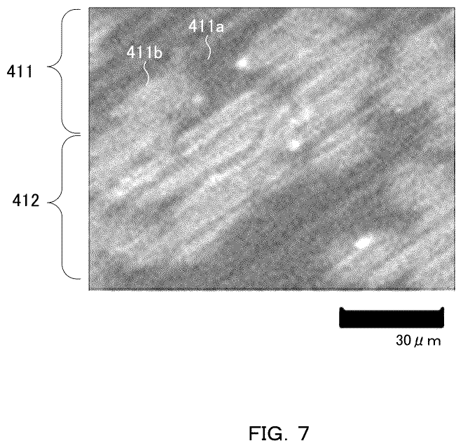

The PP-FRP member obtained in Experiment 1 was cut, and the cut surface was observed microscopically. FIG. 7 is a photomicrograph of a section. As shown in FIG. 7, it can be seen that a PP-FRP member 400 in which the composite layer 411 derived from the prepreg and the composite layer 412 derived from the nonwoven fabric are laminated is formed. It can be seen that the polypropylene 411b infiltrated into the nonwoven 411a is continuously integrated.

### Experiment 4

A heater wire with a diameter of 0.1 mm was embedded between the first and second layers in the four-layer construction to fabricate a PP-FRP member. Observation of the resulting PP-FRP member was smooth without irregularities derived from the heater wire. The PP-FRP member thus obtained was conducted without any problem when a 3V, 4.5 A current was passed through the conductive wire.

The present application claims priority from Japanese Patent Application No. 2022-165725, filed on Oct. 14, 2022, the entire contents of Japanese Patent Application No. 2022-165725 are incorporated herein by reference.

### DESCRIPTION OF SYMBOLS

10 nonwoven fabric
20 polypropylene
30 prepreg
31 to 36 prepreg
40a, 40b superposed body
41 laminated body
42 to 43 formed body
51 to 52 textile
100 PP-FRP member
111 to 114 composite layer
200 PP-FRP member
211 to 212 composite layer
231 conductive wire
300 PP-FRP member
311 to 312 composite layer
331 element
D1 core mold
D2 cavity mold
M1, M2 nozzle section
R1 to R4 roller

1. A PP-FRP member comprising:
a plurality of composite layers having sheet-like textiles and polypropylene infiltrated and anchored within mesh of the textiles,
wherein the plurality of composite layers are laminated,
the adjacent textiles are in contact with each other,
the polypropylene is filled and integrated within the mesh of the textiles,
the polypropylene comprises tackifier of 5 wt % or more and 30 wt % or less, and
the melting point of the polypropylene is 155° C. or lower.

2. The PP-FRP member according to claim 1,
wherein the textile constituting any of the plurality of composite layers is a nonwoven fabric.

3. The PP-FRP member according to claim 1,
wherein one of the textiles constituting adjacent composite layers among the plurality of composite layers is a nonwoven fabric, and
the other is a woven fabric.

4. The PP-FRP member according to claim 1, further comprising a conductive material provided between the textiles of the plurality of adjacent composite layers.

5-6. (canceled)

7. The PP-FRP member according to claim 1,
wherein when hot pressing is performed at a temperature of the softening point or higher and the melting point or lower of the polypropylene and at a temperature of 100° C. or higher and 150° C. or lower and a pressure of 2.5 MPa or lower, a change rate of length before and after the hot pressing is 1% or less.

8. A manufacturing method of PP-FRP member, comprising steps of:
superposing a plurality of prepreg sheets having a nonwoven fabric and polypropylene impregnated in the nonwoven fabric to form a first superposed body, and
hot pressing the first superposed body at a temperature of the softening point or higher and the melting point or lower of the polypropylene and at a temperature of 100° C. or higher and 150° C. or lower and at a pressure of 1.5 MPa or higher and 2.5 MPa or lower,
wherein the polypropylene comprises tackifier of 5 wt % or more and 30 wt % or less, and the melting point of the polypropylene is 155° C. or lower.

9. A manufacturing method of PP-FRP member, comprising steps of:
alternately superposing a plurality of prepreg sheets having a woven fabric and polypropylene impregnated in the woven fabric and sheet-like textiles to form a second superposed body, and
hot pressing the second superposed body at a temperature of the softening point or higher and the melting point or lower of the polypropylene and at a temperature of 100° C. or higher and 150° C. or lower and at a pressure of 1.5 MPa or higher and 2.5 MPa or lower,
wherein the polypropylene comprises tackifier of 5 wt % or more and 30 wt % or less, and the melting point of the polypropylene is 155° C. or lower.

10. (canceled)
